(19) United States
(12) Patent Application Publication
(10) Pub. No.: US 2016/0312536 A1
(43) Pub. Date: Oct. 27, 2016

(54) LINE PROJECTION BLADE TURBINE STATOR-ROTOR ASSEMBLY AND TURBINE MOTOR

(71) Applicant: CHINA UNIVERSITY OF PETROLEUM-BEIJING, Beijing (CN)

(72) Inventor: Chunfei TAN, Beijing (CN)

(21) Appl. No.: 15/032,604

(22) PCT Filed: Jan. 16, 2014
(86) PCT No.: PCT/CN2014/070721

§ 371 Date: Apr. 27, 2016

(51) Int. Cl. E21B 4/02; F01D 25/24; F01D 9/04; F01D 5/02; F01D 5/22

(52) U.S. Cl. CPC E21B 4/02; F01D 5/02; F01D 5/225; F01D 9/041; F01D 25/24; F05D 2220/30; F05D 2240/60

(57) ABSTRACT

A line projection blade turbine stator-rotor assembly and turbine motor, wherein the turbine stator-rotor assembly comprises a stator (1) and a rotor (2) that are coaxially nested; the stator (1) comprises a stator body (11), a stator blade (12) and a stator shroud (13), and the rotor (2) comprises a rotor body (21), a rotor blade (22) and a rotor shroud (23); an inner wall of the stator shroud (13) is coaxially nested with an outer wall of the rotor body (21); an intersection line of each point on an outer contour of the stator blade (12) with an isotimic meridian plane (4) corresponding thereto is a first intersection line (41) that perpendicularly intersects with a first projection straight line (51) extending through the stator shroud (13); an intersection line of each point on an outer contour of the rotor blade (22) with an isotimic meridian plane (4) corresponding thereto is a second intersection line (42) that perpendicularly intersects with a second projection straight line (52) extending through the rotor body (21). The turbine stator-rotor assembly has high hydraulic efficiency; the turbine motor has a simple structure, a high torque, and is suitable for drilling of a wellbore in various sizes.

### FIELD OF THE INVENTION

The present invention relates to a downhole powdered drill for a rotary drilling in the fields of oil, natural gas, coal bed gas, shale gas exploitation and the like, or a wellbore or a perforation drilling in the fields of geology, railway, electric power, communication and the like, in particular a stator-rotor assembly of high torque turbodrill and a turbine motor, belonging to the field of machine manufacture.

### BACKGROUND OF THE INVENTION

A turbodrilling technique is of good economic and social interest, and is one of leading-edge techniques in petroleum industry. The turbodrilling can reduce consumption and lower costs. A turbodrill is a downhole powdered drill in most early industrial applications, comprised of three parts, such as a turbine motor, a cardan shaft and a drive shaft, functions to convert fluid pressure energy of working fluid into rotating mechanical energy of an output shaft, and to drive a rotation of a drill bit, so as to fracture downhole rocks in the formations. The turbine motor is a power section of the turbodrill, and a design of turbine stator and rotor is critical to turbine motor design.

Historically, the turbodrill has always served as one of conventional downhole powdered drills in oilfields since it was invented, but it is slowly developed and fails to be well applied, the major reasons thereof are: the existing turbodrill has a high rotating speed, a small torque, a single model, a short service life, incompatible with the existing drilling equipment and instrument development level.

In view of the drawbacks of the existing turbodrill mentioned above, the inventor actively made an improvement and innovation in the existing turbine technology based on engagement in related scientific research and practice for a long time, so as to realize a high torque, a high efficiency turbine stator-rotor assembly and turbine motor.

### SUMMARY OF THE INVENTION

It is an object of the present invention to provide a line projection blade turbine stator-rotor assembly having a high torque, a high efficiency, and suitable for drilling of a wellbore in various sizes.

It is a further object of the present invention to provide a turbine motor having a high torque, a high efficiency, and suitable for drilling of a wellbore in various sizes.

In order to achieve the aforementioned objects, the present invention proposes a line projection blade turbine stator-rotor assembly comprising a stator and a rotor that are coaxially nested, center axes of the stator and the rotor lie in the same line; the stator comprises a cylindrical stator body, a number of stator blades and a circular stator shroud, and the stator blades are circumferentially arranged between the stator body and the stator shroud; the rotor comprises a cylindrical rotor body, a number of rotor blades and a circular rotor shroud, and the rotor blades are circumferentially arranged between the rotor body and the rotor shroud; an inner wall of the stator shroud is coaxially nested with an outer wall of the rotor body; an intersection line of each point on an outer contour of the stator blade with an isotimic meridian plane corresponding thereto is a first intersection line that perpendicularly intersects with a first projection straight line extending through the stator shroud; an intersection line of each point on an outer contour of the rotor blade with an isotimic meridian plane corresponding thereto is a second intersection line that perpendicularly intersects with the second projection straight line extending through the rotor body.

The line projection blade turbine stator-rotor assembly as mentioned above, wherein the first projection straight line is the center axis of the stator, and the second projection straight line is the center axis of the rotor.

The line projection blade turbine stator-rotor assembly as mentioned above, wherein each of the stator blades is arranged at same height in an axial direction of the stator, and arranged at same intervals in a circumferential direction of the stator; each of the rotor blades is arranged at same height in an axial direction of the rotor, and arranged at same intervals in a circumferential direction of the rotor.

The line projection blade turbine stator-rotor assembly as mentioned above, wherein a direction of a mounting angle of the stator blade is opposite to that of the rotor blade; the mounting angle of the stator blade gradually decreases from inside to outside in a radial direction of the stator, and the mounting angle of the rotor blade also gradually decreases from inside to outside in a radial direction of the rotor; both of a cotangent value of the mounting angle of the stator blade and that of the rotor blade are directly proportional with a radius of the corresponding isodiametric cylindrical surface.

The line projection blade turbine stator-rotor assembly as mentioned above, wherein a thickness of the stator blade gradually increases from inside to outside in a radial direction of the stator, and is directly proportional with the radius of the corresponding isodiametric cylindrical surface; a thickness of the rotor blade also gradually increases from inside to outside in a radial direction of the rotor, and is directly proportional with the radius of the corresponding isodiametric cylindrical surface.

The line projection blade turbine stator-rotor assembly as mentioned above, wherein an expanding contour of the stator blade along the isodiametric cylindrical surface comprises a leading edge of stator blade, a trailing edge of stator blade, a pressure surface of stator blade and a suction surface of stator blade; an intersection line of the leading edge of stator blade, the trailing edge of stator blade, the pressure surface of stator blade and the suction surface of stator blade with the isotimic meridian plane is a straight line, and the intersection line of the stator blade perpendicularly intersects with the center axis of the stator; the expanding contour of the rotor blade along the isodiametric cylindrical surface comprises a leading edge of rotor blade, a trailing edge of rotor blade, a pressure surface of rotor blade and a suction surface of rotor blade; an intersection line of the leading edge of rotor blade, the trailing edge of rotor blade, the pressure surface of rotor blade and the suction surface of rotor blade with the isotimic meridian plane is a straight line, and the intersection of the rotor blade perpendicularly intersects with the center axis of the rotor.

The line projection blade turbine stator-rotor assembly as mentioned above, wherein the first projection straight line and the center axis of the stator are straight lines parallel to each other, and the first projection straight line is spaced from the center axis of the stator by a space less than or equal to 50 mm; the second projection straight line and the center axis of the rotor are straight lines parallel to each other, and the second projection straight line is spaced from the center axis of the rotor by a space less than or equal to 50 mm.

The present invention also provides a turbine motor comprising a turbine motor spindle and a motor shell, wherein the turbine stator-rotor assembly as mentioned above is socketed on the turbine motor spindle.

The turbine motor as mentioned above, wherein the turbine stator-rotor assembly is stacked in 50 to 300 stages in the axial direction of the turbine motor spindle so as to form a high torque turbine motor with 50 to 300 stages of turbine stator-rotor.

As compared with the prior art, the present invention has following features and advantages:

1. The turbine stator-rotor assembly of the present invention has high hydraulic efficiency;
2. The turbine motor of the present invention has a simple structure, a high torque, and is suitable for drilling of a wellbore in various sizes.

### BRIEF DESCRIPTION OF THE DRAWINGS

The drawings described herein are for illustration purposes only, and are not intended to limit the scope of the present disclosure in any way. In addition, shapes and proportional sizes of each part in figures are only illustrative to aid in the understanding of the present invention, and are not intended to specifically limit shapes and proportional sizes of each part of the present invention. Those skilled in the art, having the benefit of teachings herein, can select various possible shapes and proportional sizes according to specific condition, so as to implement the present invention.

FIG. 1 is a cross-sectional schematic view of the structure of a line projection blade turbine stator-rotor assembly of the present invention;

FIG. 2 is a partially cut-away schematic view of the structure of the line projection blade turbine stator-rotor assembly of the present invention;

FIG. 3 is a cross-sectional schematic view of the structure of a stator of the present invention;

FIG. 4 is a perspective schematic view of the structure of the stator of the present invention;

FIG. 5 is a schematic view of stator blades of the present invention expanding along isodiametric cylindrical surface (S=1) of the blade tip;

FIG. 6 is a cut-away schematic view of the stator of the present invention along isotimic meridian plane (I=0.5);

FIG. 7 is a cross-sectional schematic view of the structure of a rotor of the present invention;

FIG. 8 is a perspective schematic view of the structure of the rotor of the present invention;

FIG. 9 is a schematic view of rotor blades of the present invention expanding along isodiametric cylindrical surface (S=1) of the blade tip;

FIG. 10 is a cut-away schematic view of the rotor of the present invention along isotimic meridian plane (I=0.5); and

FIG. 11 is a cross-sectional schematic view of the structure of a turbine motor of the present invention.

### LIST OF THE REFERENCE SIGNS

1—stator; 11—stator body; 12—stator blade; 121—stator blade tip; 122—stator blade bottom; 123—leading edge of stator blade; 124—trailing edge of stator blade; 125—pressure surface of stator blade; 126—suction surface of stator blade; 13—stator shroud;
2—rotor; 21—rotor body; 22—rotor blade; 221—rotor blade tip; 222—rotor blade bottom; 223—leading edge of rotor blade; 224—trailing edge of rotor blade; 225—pressure surface of rotor blade; 226—suction surface of rotor blade; 23—rotor shroud; 24—boss;
3—isodiametric cylindrical surface; 4—isotimic meridian plane; 41—first intersection line; 42—second intersection line; 51—first projection straight line; 52—second projection straight line; 6—spindle of turbine motor; 7—motor shell.

### DETAILED DESCRIPTION OF THE INVENTION

Details of the present invention will become more apparent with reference to the accompanying drawings and the detailed description of the invention. However, the detailed description of the invention described herein is for purposes of explaining the invention only and not to be construed as limiting the invention in any way. Any possible variation based on the present invention can be envisaged by those skilled in the art, having the benefit of teachings herein, and these shall be considered to be within the scope of the invention.

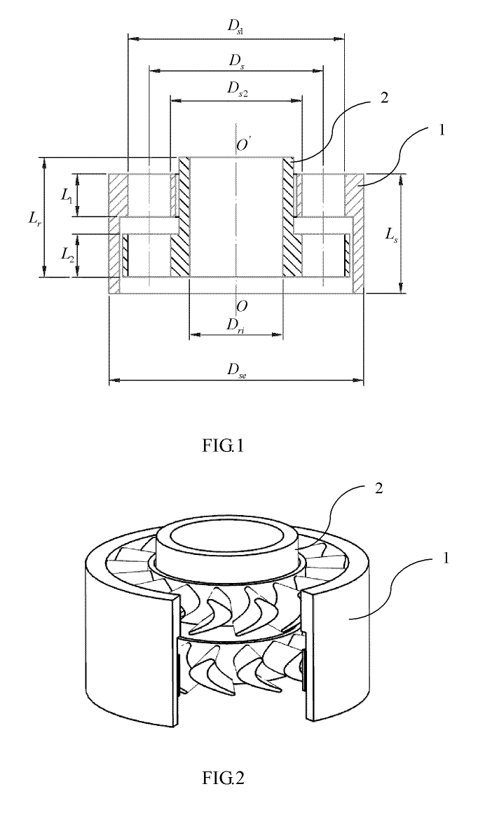

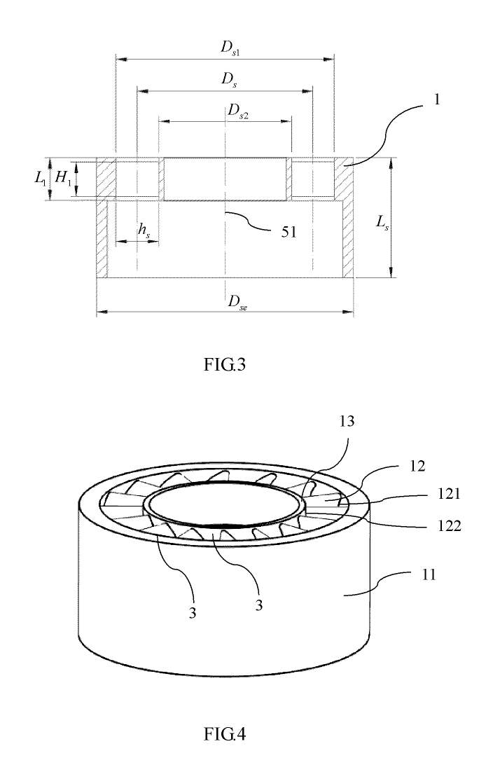

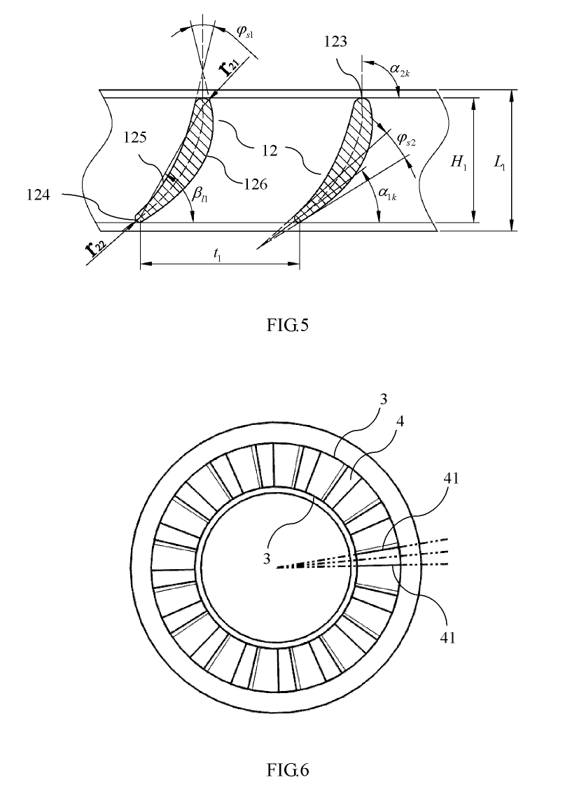

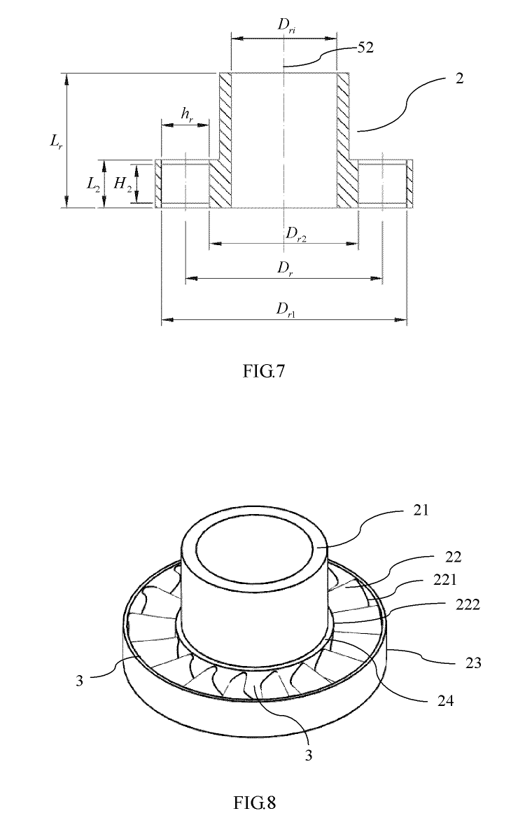

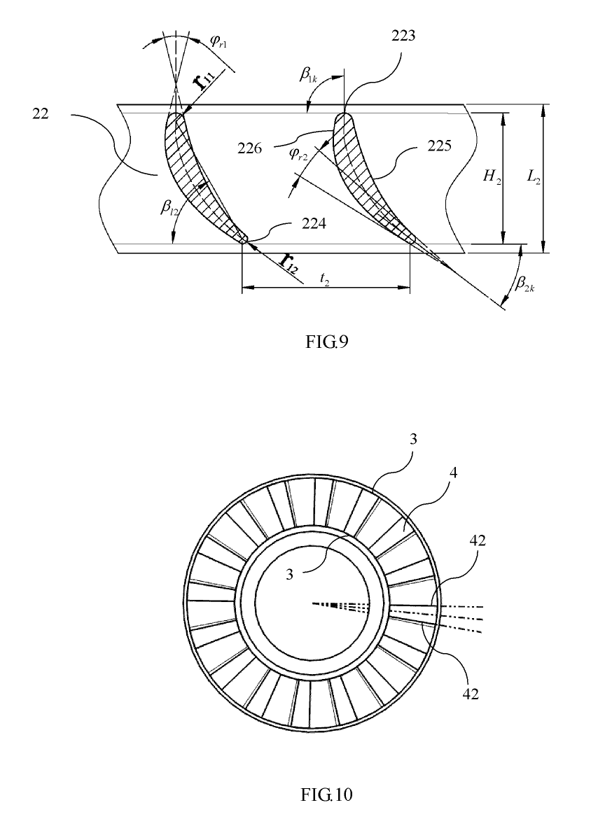

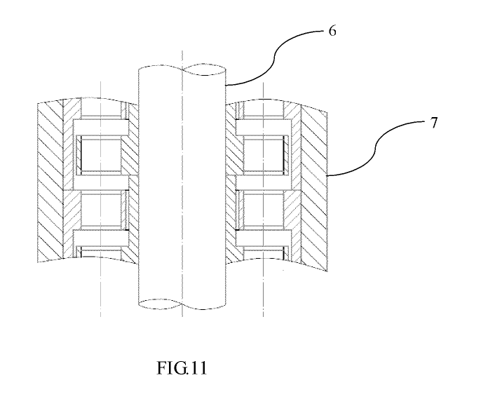

Please refer to FIGS. 1 to 11, FIG. 1 is a cross-sectional schematic view of the structure of a line projection blade turbine stator-rotor assembly of the present invention; FIG. 2 is a partially cut-away schematic view of the structure of the line projection blade turbine stator-rotor assembly of the present invention; FIG. 3 is a cross-sectional schematic view of the structure of a stator of the present invention; FIG. 4 is a perspective schematic view of the structure of the stator of the present invention; FIG. 5 is a schematic view of stator blades of the present invention expanding along isodiametric cylindrical surface (S=1) of blade tip; FIG. 6 is a cut-away schematic view of the stator of the present invention along isotimic meridian plane (I=0.5); FIG. 7 is a cross-sectional schematic view of the structure of a rotor of the present invention; FIG. 8 is a perspective schematic view of the structure of the rotor of the present invention; FIG. 9 is a schematic view of rotor blades of the present invention expanding along isodiametric cylindrical surface (S=1) of blade tip; FIG. 10 is a cut-away schematic view of the rotor of the present invention along isotimic meridian plane (I=0.5); and FIG. 11 is a cross-sectional schematic view of the structure of a turbine motor of the present invention.

As shown in FIGS. 1 to 10, the present invention proposes a line projection blade turbine stator-rotor assembly comprising a stator 1 and a rotor 2 that are coaxially nested, center axes OO′ of the stator 1 and the rotor 2 lie in the same line, the stator 1 comprises a cylindrical stator body 11, a number of stator blades 12 and a circular stator shroud 13, and the stator blades 12 are circumferentially arranged between the stator body 11 and the stator shroud 13 (as shown in FIG. 4). The stator blades 12 are uniformly spaced along an inner circumferential surface of the stator body 11, and an outer wall of the stator shroud 13 is connected to a blade bottom 122 of the stator blade 12. The rotor 2 comprises a cylindrical rotor body 21, a number of rotor blades 22 and a circular rotor shroud 23, and the rotor blades 22 are circumferentially arranged between the rotor body 21 and the rotor shroud 23. As shown in FIG. 8, a boss 24 projecting radially is provided on an outer circumference of one end of the rotor body 21, the rotor blades 22 are uniformly spaced along an outer circumferential surface of the boss 24, the rotor shroud 23 is socketed on a blade tip 221 of the rotor blades 22, such that the rotor body 21, the rotor blades 22, and the rotor shroud 23 form the rotor 2 in a unitary structure, which may allow a spindle of a turbine motor to extend through the rotor body 21 and to be rotated in synchronization with the rotor 2. An inner wall of the stator shroud 13 and an outer wall of the rotor body 21 are coaxially nested so that the stator 1 is fitted in the rotor 2.

In the present invention, blade profiles of the stator blades 12 and the rotor blades 22 are formed by line projection. The side where the stator blades 12 adjoin the stator body 11 is a stator blade tip 121, and the side where they adjoin the stator shroud 13 is a stator blade bottom 122. There is a plurality of cylindrical surfaces with central axis thereof coaxial with the stator body 11 and the stator shroud 13 between the stator blade tip 121 and stator blade bottom 122, each cylindrical surface is referred to as an isodiametric cylindrical surface 3. The position of any isodiametric cylindrical surface 3 between the stator blade tip 121 and the stator blade bottom 122 relative to the stator blade tip 121 and the stator blade bottom 122 is indicated with S, 0≦S≦1.0; when the isodiametric cylindrical surface 3 coincides with the cylindrical surface where the stator blade bottom 122 is located, S=0, and when the isodiametric cylindrical surface 3 coincides with the cylindrical surface where the stator blade tip 121 is located, S=1.0. Correspondingly, the side where the rotor blades 22 adjoin the rotor body 21 is a rotor blade bottom 222, and the side where they adjoin the rotor shroud 23 is a rotor blade tip 221. There is a plurality of cylindrical surfaces with central axis thereof coaxial with the rotor body 21 and the rotor shroud 23 between the rotor blade tip 221 and rotor blade bottom 222, each cylindrical surface is also referred to as an isodiametric cylindrical surface 3. The position of any isodiametric cylindrical surface 3 between the rotor blade tip 221 and the rotor blade bottom 222 relative to the rotor blade tip 221 and the rotor blade bottom 222 is indicated with S, 0≦S≦1.0; when the isodiametric cylindrical surface 3 coincides with the cylindrical surface where the rotor blade bottom 222 is located, S=0, and when the isodiametric cylindrical surface 3 coincides with the cylindrical surface where the rotor blade tip 221 is located, S=1.0. The stator 1 is arranged by being nested and superimposed with the rotor 2 one on top of the other with the central axis thereof are coaxial, and therefore the isodiametric cylindrical surface on the stator 1 and the isodiametric cylindrical surface on the rotor 2 with the same value of S are the same isodiametric cylindrical surface.

In the present invention, a plane perpendicularly intersecting with the central axes of the stator 1 and the rotor 2 is referred to as a meridian plane. As shown in FIG. 5, the position of the meridian plane between an upper end (inlet) and a lower end (outlet) of the stator blades 12 relative to the upper and lower ends is represented by I, 0≦I≦1.0. Wherein the meridian plane with the same value of I is referred as an isotimic meridian plane 4; when the isotimic meridian plane 4 is tangential to an upper end of the stator blades 12, I=0; when the isotimic meridian plane 4 is tangential to a lower end of the stator blades 12, I=1. Correspondingly, as shown in

FIG. 9, the position of the meridian plane between the upper end (inlet) and lower end (outlet) of the rotor blades 22 relative to the upper and lower ends is represented by I, 0≦I≦1.0. . Wherein the meridian plane with the same value of I is also referred as the isotimic meridian plane 4; when the isotimic meridian plane 4 is tangential to an upper end of the rotor blades 22, I=0, and when the isotimic meridian plane 4 is tangential to a lower end of the rotor blades 12, I=1.

In the present invention, as shown in FIG. 6, an intersection line of each point on an outer contour of the stator blade 12 with the isotimic meridian plane 4 corresponding thereto is a first intersection line 41 that perpendicularly intersects with a first projection straight line 51 extending through the stator shroud 13; and an intersection line of each point on an outer contour of the rotor blade 22 with the isotimic meridian plane 4 corresponding thereto is a second intersection line 42 that perpendicularly intersects with the second projection straight line 52 extending through the rotor body 21. In the present invention, the first projection straight line 51 and the second projection straight line 52 can be straight lines coinciding with each other or ones not coinciding with each other, provided that it ensures that the first projection straight line 51 is extending through the stator shroud 13, and the second projection straight line is extending through the rotor body 21. The experiment suggests that, the line projection blade turbine stator-rotor assembly of the present invention has a high torque, a high hydraulic efficiency, and is suitable for drilling of a wellbore in various sizes.

In the present embodiment, it is preferable that the first projection straight line 51 is the center axis of the stator 1, and the second projection straight line 52 is the center axis of the rotor 2.

Further, each of the stator blades 12 is arranged at same height in an axial direction of the stator 1, and arranged at same intervals in a circumferential direction of the stator 1; each of the rotor blades 22 is arranged at same height in an axial direction of the rotor 2, and arranged at same intervals in a circumferential direction of the rotor 2.

Further, as shown in FIGS. 5 and 9, the rotor blades 22 and the stator blades 12 are obliquely arranged relative to the center axis of the rotor 2 and the stator 1, and the rotor blades 22 are sloped in the opposite direction to the stator blades 12. A direction of a mounting angle βₗ₁ of the stator blade 12 is opposite to that of βₗ₂ of the rotor blade 22, which is in agreement with right-hand screw rule, i.e. the stator blades 12 undergo right hand rotation, and the rotor blades 22 undergo left hand rotation, the mounting angle βₗ₁ of the stator blade 12 gradually decreases from inside to outside in the radial direction of the stator 1, and the mounting angle βₗ₂ of the rotor blade 22 also gradually decreases from inside to outside in the radial direction of the rotor 2; and the both of a cotangent value of the mounting angles βₗ₁ and βₗ₂ of stator blade and rotor blade are directly proportional with the radius of the corresponding isodiametric cylindrical surface.

Further, as shown in FIGS. 5 and 9, a thickness of the stator blades 12 gradually increases from inside to outside in the radial direction of the stator 1, and is directly proportional with the radius of the corresponding isodiametric cylindrical surface 3; a thickness of the rotor blades also gradually increases from inside to outside in the radial direction of the rotor, and is also directly proportional with the radius of the corresponding isodiametric cylindrical surface 3.

In the present invention, as shown in FIGS. 5 and 9, an expanding contour of the stator blade 12 along the isodiametric cylindrical surface 3 comprises a leading edge of stator blade 123, a trailing edge of stator blade 124, a pressure surface of stator blade 125 and a suction surface of stator blade 126. An intersection line of the leading edge of stator blade 123, the trailing edge of stator blade 124, the pressure surface of stator blade 125 and the suction surface of stator blade 126 with the isotimic meridian plane 4 is a straight line, and the intersection line of the stator blade 12 perpendicularly intersects with the center axis of the stator; the expanding contour of the rotor blade 22 along the isodiametric cylindrical surface 3 comprises a leading edge of rotor blade 223, a trailing edge of rotor blade 224, a pressure surface of rotor blade 225 and a suction surface of rotor blade 226. An intersection line of the leading edge of rotor blade 223, the trailing edge of rotor blade 224, the pressure surface of rotor blade 225 and the suction surface of rotor blade 226 with the isotimic meridian plane 4 is also a straight line, and the intersection line of the rotor blade 22 also perpendicularly intersects with the center axis of the rotor 2.

Further, the first projection straight line 51 and the center axis of the stator 1 are straight lines parallel to each other, and the first projection straight line 51 is spaced from the center axis of the stator 1 by a space less than or equal to 50 mm; and the second projection straight line 52 and the center axis of the rotor 2 are straight lines parallel to each other, and the second projection straight line 52 is spaced from the center axis of the rotor 2 by a space less than or equal to 50 mm.

Further, as shown in FIGS. 1, 3 and 7, the axial height of the stator 1 and the rotor 2 is Lₛ=Lᵣ20˜60 mm, and an external diameter of the stator 1 is Dₛₑ=50˜300 mm, and an internal diameter of the rotor 2 is Dᵣᵢ=20˜200 mm.

Further, as shown in FIGS. 1, 3 and 7, an axial height of the stator shroud 13 is L₁=7˜20 mm, an axial height of the rotor shroud L₂=7˜20 mm; an axial height of the stator blade 12 is H₁=7˜20 mm, and an axial height of the rotor blade 22 is H₂=7˜20 mm.

Further, as shown in FIGS. 1, 2, 3 and 7, an inner circumferential diameter of the rotor shroud 23 is Dᵣ₁, and an inner circumferential diameter of the stator body 11 is Dₛ₁, that is, an external diameter of flow passage of this stator-rotor assembly is D₁ with the relationship of D₁=Dᵣ₁=Dₛ₁=40˜280 mm; an outer circumferential diameter of the boss 24 of the rotor body 21 is Dᵣ₂, and an outer circumferential diameter of the stator shroud 13 is Dₛ₂, that is, an internal diameter of flow passage of this stator-rotor assembly is D₂ with the relationship of D₂=Dᵣ₂=Dₛ₂=30˜220 mm; an arithmetic mean value of the external diameter of the flow passage D₁ and the internal diameter of the flow passage D₂ is an average diameter D of the flow passage with the relationship of D=(D₁+D₂)/2=35˜250 mm; half of difference of the external diameter of the flow passage D₁ and the internal diameter of the flow passage D₂ is a width of flow passage h with the relationship of h=hᵣ=hₛ, h=(D₁−D₂)/2=5˜125 mm (note: Dᵣ₁ and Dₛ₁, Dᵣ₂ and Dₛ₂ may also have different values, if necessary).

Further, as shown in FIGS. 4 and 8, the number n₁ of the stator blades 12 and the number n₂ of the rotor blades 22 are n₁₌10˜60, n₂=10˜60, respectively, so as to satisfy requirements of different operating conditions.

Further, as shown in FIGS. 5 and 9, a pitch between two adjacent stator blades 12 is t₁, t₁=5.0˜15.0 mm; a pitch between two adjacent rotor blades 22 is t₂, t₂=5.0˜15.0 mm. An inlet angle of the stator blade 12 is α₂ₖ, α₂ₖ=30°˜150°; an inlet angle of the rotor blade 22 is β₁ₖ, β₁ₖ=30°˜150°. An outlet angle of the stator blade 12 is α₁ₖ, α₁ₖ=5°˜85°; an outlet angle of the rotor blade 22 is β₂ₖ, β₂ₖ=5°˜85°. A leading edge radius of the stator blade 12 is r₂₁, r₂₁=0.1˜3.0 mm; a trailing edge radius is r₂₂, r₂₂=0.1˜3.0 mm. A leading edge radius of the rotor blade 22 is r₁₁, r₁₁=0.1˜3.0 mm; a trailing edge radius is r₁₂, r₁₂=0.1˜3.0 mm. A leading edge taper angle of the stator blade 12 is φₛ₁, 1°≦φₛ₁≦75°; a leading edge taper angle of the rotor blade 22 is φᵣ₁, 1°≦φᵣ₁≦75°. A trailing edge taper angle of the stator blade 12 is φₛ₂, 1°≦φₛ₂≦75°; a trailing edge taper angle of the rotor blade 22 is φᵣ₂, 1°≦φᵣ₂≦75°. A mounting angle of the stator blade 12 is βₗ₁, βₗ₁=20°˜90°; a mounting angle of the rotor blade 22 is βₗ₂, βₗ₂=20°˜90°.

Further, as shown in FIGS. 6 and 10, the stator blades 12 or the rotor blades 22 intersect with the isotimic meridian plane 4 with the value of I is 0.5, both of the intersection straight lines 41, 42 of the pressure surface of stator blade 125 and the suction surface of stator blade 126 or the pressure surface of rotor blade 225 and suction surface of rotor blade 226 with the corresponding isotimic meridian plane 4 point to the radius direction, a circumferential thickness of the stator blades 12 and a circumferential thickness of the rotor blades 22 gradually increase (from inside to outside) in the radial direction, directly proportional with the radius of the isodiametric cylindrical surface 3.

It is remarked that, definitions of inlet angle, outlet angle, leading edge radius, trailing edge radius, leading edge taper angle, trailing edge taper angle, blade mounting angle of the aforementioned turbine stator blades 12 and rotor blades 22 are common knowledge in the art, and therefore are not further described herein.

In summary, owing to the above-mentioned structural design, the present invention has advantages of simple structure, low pressure differential, high torque, and high hydraulic efficiency.

As shown in FIG. 11, the invention further proposes a turbine motor comprising a turbine motor spindle 6 and a motor shell 7, the turbine motor spindle 6 is socketed with the turbine stator-rotor assembly as mentioned above. The turbine motor of the present invention has a simple structure, a high torque, and is suitable for drilling of a wellbore in various sizes.

Further, the turbine stator-rotor assembly is stacked in 50 to 300 stages along the axial direction of the turbine motor spindle 6 so as to form a high torque turbine motor with 50 to 300 stages of turbine stator-rotor, the turbine motor of the present invention is applicable to a turbodrill and a bottom hole assembly for drilling of a wellbore or a perforation, with a diameter of Φ60 to Φ600 mm.

For the detailed explanation of each embodiment mentioned above, it is an object of only explaining the invention to facilitate a better understanding of the present invention. However, these descriptions can in no way to be construed as limiting of the present invention, particularly, each feature described in different embodiments can also be combined with one another in any combination to constitute other embodiments, unless explicitly described to the contrary, it should be understood that these features can be applied to any one embodiment, and are not only restricted to the above described embodiments.

1. A line projection blade turbine stator-rotor assembly comprising a stator and a rotor that are coaxially nested, center axes of the stator and the rotor lie in the same line; the stator comprises a cylindrical stator body, a number of stator blades and a circular stator shroud, and the stator blades are circumferentially arranged between the stator body and the stator shroud; the rotor comprises a cylindrical rotor body, a number of rotor blades and a circular rotor shroud, and the rotor blades are circumferentially arranged between the rotor body and the rotor shroud; an inner wall of the stator shroud is coaxially nested with an outer wall of the rotor body, wherein an intersection line of each point on an outer contour of the stator blade with an isotimic meridian plane corresponding thereto is a first intersection line that perpendicularly intersects with a first projection straight line extending through the stator shroud; an intersection line of each point on an outer contour of the rotor blade with an isotimic meridian plane corresponding thereto is a second intersection line that perpendicularly intersects with a second projection straight line extending through the rotor body.

2. The line projection blade turbine stator-rotor assembly as claimed in claim 1, wherein the first projection straight line is the center axis of the stator, and the second projection straight line is the center axis of the rotor.

3. The line projection blade turbine stator-rotor assembly as claimed in claim 1, wherein each of the stator blades is arranged at same height in an axial direction of the stator, and arranged at same intervals in a circumferential direction of the stator; each of the rotor blades is arranged at same height in an axial direction of the rotor, and arranged at same intervals in a circumferential direction of the rotor and the like.

4. The line projection blade turbine stator-rotor assembly as claimed in claim 1 or 2, wherein a direction of a mounting angle of the stator blade is opposite to that of the rotor blade; the mounting angle of the stator blade gradually decreases from inside to outside in a radial direction of the stator, and the mounting angle of the rotor blade also gradually decreases from inside to outside in a radial direction of the rotor; both of a cotangent value of the mounting angle of the stator blade and that of the rotor blade are directly proportional with a radius of the corresponding isodiametric cylindrical surface.

5. The line projection blade turbine stator-rotor assembly as claimed in claim 1, wherein a thickness of the stator blade gradually increases from inside to outside in a radial direction of the stator, and is directly proportional with the radius of the corresponding isodiametric cylindrical surface; a thickness of the rotor blade also gradually increases from inside to outside in a radial direction of the rotor, and is directly proportional with the radius of the corresponding isodiametric cylindrical surface.

6. The line projection blade turbine stator-rotor assembly as claimed in claim 1, wherein an expanding contour of the stator blade along the isodiametric cylindrical surface comprises a leading edge of stator blade, a trailing edge of stator blade, a pressure surface of stator blade and a suction surface of stator blade; an intersection line of the leading edge of stator blade, the trailing edge of stator blade, the pressure surface of stator blade and the suction surface of stator blade with the isotimic meridian plane is a straight line, and the intersection line of the stator blade perpendicularly intersects with the center axis of the stator; an expanding contour of the rotor blade along the isodiametric cylindrical surface comprises a leading edge of rotor blade, a trailing edge of rotor blade, a pressure surface of rotor blade and a suction surface of rotor blade; an intersection line of the leading edge of rotor blade, the trailing edge of rotor blade, the pressure surface of rotor blade and the suction surface of rotor blade with the isotimic meridian plane is a straight line, and the intersection line of the rotor blade also perpendicularly intersects with the center axis of the rotor.

7. The line projection blade turbine stator-rotor assembly as claimed in claim 1, wherein the first projection straight line and the center axis of the stator are straight lines parallel to each other, and the first projection straight line is spaced from the center axis of the stator by a space less than or equal to 50 mm; the second projection straight line and the center axis of the rotor are straight lines parallel to each other, and the second projection straight line is spaced from the center axis of the rotor by a space less than or equal to 50 mm.

8. A turbine motor comprising a turbine motor spindle and a motor shell, wherein the turbine stator-rotor assembly as claimed in claim 1 is socketed on the turbine motor spindle.

9. The turbine motor as claimed in claim 8, wherein the turbine stator-rotor assembly is stacked in 50 to 300 stages in the axial direction of the turbine motor spindle so as to form a high torque turbine motor with 50 to 300 stages of turbine stator-rotor.

10. The line projection blade turbine stator-rotor assembly as claimed in claim 2, wherein each of the stator blades is arranged at same height in an axial direction of the stator, and arranged at same intervals in a circumferential direction of the stator; each of the rotor blades is arranged at same height in an axial direction of the rotor, and arranged at same intervals in a circumferential direction of the rotor and the like.

11. The line projection blade turbine stator-rotor assembly as claimed in claim 2, wherein a direction of a mounting angle of the stator blade is opposite to that of the rotor blade; the mounting angle of the stator blade gradually decreases from inside to outside in a radial direction of the stator, and the mounting angle of the rotor blade also gradually decreases from inside to outside in a radial direction of the rotor; both of a cotangent value of the mounting angle of the stator blade and that of the rotor blade are directly proportional with a radius of the corresponding isodiametric cylindrical surface.

12. The line projection blade turbine stator-rotor assembly as claimed in claim 2, wherein a thickness of the stator blade gradually increases from inside to outside in a radial direction of the stator, and is directly proportional with the radius of the corresponding isodiametric cylindrical surface; a thickness of the rotor blade also gradually increases from inside to outside in a radial direction of the rotor, and is directly proportional with the radius of the corresponding isodiametric cylindrical surface.

13. The line projection blade turbine stator-rotor assembly as claimed in claim 2, wherein an expanding contour of the stator blade along the isodiametric cylindrical surface comprises a leading edge of stator blade, a trailing edge of stator blade, a pressure surface of stator blade and a suction surface of stator blade; an intersection line of the leading edge of stator blade, the trailing edge of stator blade, the pressure surface of stator blade and the suction surface of stator blade with the isotimic meridian plane is a straight line, and the intersection line of the stator blade perpendicularly intersects with the center axis of the stator; an expanding contour of the rotor blade along the isodiametric cylindrical surface comprises a leading edge of rotor blade, a trailing edge of rotor blade, a pressure surface of rotor blade and a suction surface of rotor blade; an intersection line of the leading edge of rotor blade, the trailing edge of rotor blade, the pressure surface of rotor blade and the suction surface of rotor blade with the isotimic meridian plane is a straight line, and the intersection line of the rotor blade also perpendicularly intersects with the center axis of the rotor.

14. A turbine motor comprising a turbine motor spindle and a motor shell, wherein the turbine stator-rotor assembly as claimed in claim 2 is socketed on the turbine motor spindle.

15. The turbine motor as claimed in claim 14, wherein the turbine stator-rotor assembly is stacked in 50 to 300 stages in the axial direction of the turbine motor spindle so as to form a high torque turbine motor with 50 to 300 stages of turbine stator-rotor.
